(19) United States
(12) Patent Application Publication
(10) Pub. No.: US 2008/0044627 A1
(43) Pub. Date: Feb. 21, 2008

(54) REFLECTIVE DECORATIVE SURFACE COATING AND A DECORATIVE WATER-BORNE SURFACE COATING SYSTEM HAVING AT LEAST ONE BASECOAT

(76) Inventors: RHEA G. GROSECLOSE, Strongsville, OH (US); J. Dan Vidikan, Seville, OH (US); Patrick K. Donovan, Parma, OH (US)

Correspondence Address: THE GLIDDEN COMPANY, 15885 WEST SPRAGUE ROAD, STRONGVILLE, OH, 44136, US

(21) Appl. No.: 11/837,132

(22) Filed: Aug. 10, 2007

Related U.S. Application Data
(60) Provisional application No. 60/838,408, filed on Aug. 17, 2006.

(51) Int. Cl. B32B 5/16; B05D 1/36

(52) U.S. Cl. 428/144; 427/402; 428/332

(57) ABSTRACT

A single-layer coating and a multi-layered water-borne surface coating system that can be applied as a decorative surface coating by professional painting contractors, and do-it-yourself home remodelers, on interior decorative surfaces (e.g., walls, ceilings, partitions, archways, etc.) that provides a reflective “sparkling” finish once it has air dried. The continued development of new and different architectural coatings products has been a prime focus for all coating manufacturers. The development of specialized coating products that can be applied by both the professional painting contractors and experienced do-it-yourself home remodelers has been the focus of much attention and development. The interior decorative surface coating described herein is uniquely qualified to fill this very important niche market.

This application claims the benefit including that of priority under 35 U.S.C. 119(e) of U.S. Provisional Patent Application Ser. No. 60/838,408, filed Aug. 17, 2006, entitled “A Reflective Decorative Surface Coating and a Decorative Water-borne Surface Coating System having at Least One Basecoat,” the complete disclosure of which is hereby incorporated by reference.

### FIELD OF DISCLOSURE

The present disclosure generally relates to a single-layer decorative surface coating and a multi-layered decorative surface coating system, usually a 2-coat system, which is applied onto an interior decorative surface (e.g., wall, ceiling, partition, archway, and the like) that provides a reflective finish once it has air dried.

### INTRODUCTION TO THE DISCLOSURE

Recently the nature and scope of specialty finishes for coating or covering substrates has evolved and continues to evolve at an ever increasing pace. As such, coatings manufacturers are on a constant vigil to develop new or different coatings in order to capture a segment of this growing market. In order to attract and participate in this market, coatings manufactures are challenged to provide a wide array of products to suit the curiosity and demands of its contractors, as well as its DIY (Do-It-Yourself) customers.

One patent document GB 2 234 249 discloses the use of reflective particles in coatings, described as “solid transparent lenticular particles which exhibit a refractive index of about 1.4 to 1.88”. This coating also relies upon the addition of a small amount of opacifying agent(s) such as titanium dioxide or Spindrift® in order to achieve its desired property of “gleamy”. However such additions of some opacifiers to a coating used as a top coat over at least opaque base coat can make the top coat less transparent and actually a little cloudy. Such cloudiness can limit the range of colors that can be used in the at least one base coat layer over which the top coat is applied. Additionally the range of refractive index in the coating disclosed in GB 2 234 249 can restrict the use of a wider palette of colors in the base coat while still achieving an adequate reflective property from the topcoat.

During the intervening period of time, approximately fifteen years, from the publication of the aforementioned patent document, there has not been a deluge of products being developed to address this segment of the decorative market. The coating art and the specialty finish segment of the coating art can benefit from having a wider range of base coat palette choices available with a reflective type of topcoat to allow choice of a sparkling finish over a wider latitude of colors.

### SUMMARY OF THE DISCLOSURE

In the following description, certain aspects and embodiments will become evident. It should be understood that the disclosure, in its broadest sense, could be practiced without having one or more of the features of these aspects and embodiments. It should be understood that these aspects and embodiments are merely illustrative. In one aspect of the present disclosure a system is described which comprises at least one opaque decorative surface coating, accompanied with a substantially transparent top decorative surface coating. When applied as a system, the substantially transparent top decorative coating imparts a natural glimmer or elegance to the opaque decorative base coat. The application of the top coat can be by common painting techniques or methods or in one aspect of the present invention by a new technique or method. In this one embodiment, the technique incorporates a crisscross rolling technique which is particularly suitable for highlighting certain aspects of the top coat finish (e.g., the sparkling qualities of the reflective beads, etc.). The “sparkling finish” enhances the ability of the decorative coating to reflect natural sunlight, artificial room lighting such as that which would be emitted from either incandescent or fluorescent lighting fixtures, as well as other forms of natural lighting such as that which would be given off by candles.

In another aspect of the present disclosure, the substantially transparent top decorative surface coating can be obtained separately for application over almost any existing basecoat, with limitations, or a basecoat obtained separately from any commercially available color palette. Generally, the limitations mentioned above are in regard to the sheen of the at least one base coat or existing base coating.

In addition, the disclosure sets forth basic recommendations for application of the substantially transparent decorative surface coating which are aimed at maximizing the desired results, results which can be achieved by the professional painting contractors as well as the experienced DIY painters.

### DETAILED DESCRIPTION OF THE DISCLOSURE

The present disclosure relates to a water-borne decorative surface coating that, when dried, exhibits a reflective finish which can have a “sparkling” appearance. In this specification and claims the following terms whether in the singular, plural or possessive have the following general meanings to assist in describing the invention without limiting the scope of the invention.

As used herein, “water-borne coatings” have their art recognized meaning which allows for the inclusion of minor amounts of co-solvents and other volatile organic material provided water constitutes more than 50 percent, and preferably at least 80 percent of the volatile phase, so that even with the presence of minor amounts of organic solvents these coatings are still regarded as water-borne since the majority of the volatile solvent present in the liquid coating is comprised of water; and

Also herein, “a”, “an”, “the”, “at least”, and the like, are used interchangeably.

All percentages, ratios and proportions herein are by weight, unless otherwise specified. All temperatures are in degrees Celsius (° C.) unless otherwise specified. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements. As a whole, all values mentioned are indicated in conformity with the international legislation on the one hand, and in amounts pertaining to the mass on another hand. Unless otherwise stated, the proportions of the components in the compositions described are given in percentage pertaining to the total mass of the mixture of these components.

Also herein, the terms “comprised of”, “comprising”, “including”, “containing”, “having” and the like shall be read expansively and not be construed as having a limiting meaning where these terms appear in the description and claims. Of course, the inventions illustratively described herein may suitably be practiced in the absence of any element or elements, limitation or limitations, not specifically disclosed herein. Also the terms, expressions, and definitions employed herein have been used as terms of description and not of limitation, such terms, expressions and definitions are used without any intent to exclude any equivalents of the features or parts of features shown and described. It should be recognized that various modifications are possible within the scope of the invention claimed. Thus, it should be understood that although the present invention has been specifically disclosed by preferred embodiments and optional features, modification and variations of such embodiments of the invention herein disclosed adopted or applied by those skilled in the art are considered to be within the scope of this invention.

Also herein, the term “essentially free” is not meant to be all exclusive, so as to absolutely limit the presence of any trace quantities of the materials being described which might occur as the result of raw materials or components having trace amounts, equipment contamination, settling of airborne contaminants, or the like which might occur as the result of an unrelated process, or other activity in close proximity to the one being used to make the coatings which are the subject of this disclosure.

Also herein, the term “intentionally added” is being used to describe an act or a process whereby the ingredient would purposefully be added as an ingredient to the formulation. Likewise, essentially free of intentionally added ingredients would indicate that there is no overt act taking place which would allow the ingredient to be introduced into the formulation, but nonetheless there may be trace quantities of these materials present merely as a consequence of the making the coating.

Also herein, all numbers used in the specification and claims are to be understood as being modified in all instances by the term “about”. Accordingly, unless indicated to the contrary, the numerical values used in the specification and claims may vary depending upon the desired properties which are sought to be obtained by the present disclosure.

Also herein, the terminology “other than a flat finish” has been used to describe a finish which might otherwise be described as a satin, eggshell, semi-gloss or gloss finish or sheen. For purposes of this disclosure other than a flat finish is meant to describe the at least one base coat as having a gloss greater than 5 gloss units when measured at an angle of 85 degrees using any commercially-available gloss meter such as a Byk Gardner. Although generally accepted within the industry as a term of art, flat can be described somewhat differently depending upon the manufacturer. This description is being provided as a means of clarification, and is not otherwise meant to limit the scope of the invention.

Also herein, the term “substantially transparent” is meant to describe a decorative coating layer that is mostly clear, translucent or transparent, as opposed to a base coating layer that has pigmentation other than that of the substantially transparent resin. As such, there might actually be a slight coloration to the otherwise substantially transparent top coating layer, but that coloration shall not be of the nature or extent that it would fully block the transmission of visible light so as to block the viewing of the underlying at least one base coat as one would expect with an opaque coating layer.

Also herein, the term “opaque” is meant as neither being transparent nor translucent.

Also herein, the term “sparkling” is meant to describe a range of reflective properties that can be demonstrated when visible light of any wavelength(s) in the range of 380 to 700 nanometers (“nm”) strike upon the partially exposed portions of the reflective particles, glass beads, or glass spheres.

Also herein, the term “substrate” is meant to include a range of similar or dissimilar substrates such as wood, particle board, plaster, plasterboard, gypsum board, drywall, sheetrock, and other similar materials which provides a surface on which a decorative surface coating can be applied.

One embodiment of the coating system disclosed herein has at least one opaque base coat and at least one top coat with reflective material having a refractive index above 1.88. Generally, the at least one base coat can be any coating such as paint available in the marketplace but it is more suitable to use paint with other than a flat finish. The at least one base coat that is opaque can be of any color including the darker or deeper colors such as color hues of black, blue, green, yellow, red, or any combination thereof. Generally the colors can be any of those offered by any paint manufacturer. One suitable coating color system and its notation is available from Imperial Chemical Industries PLC and The Glidden Company (d/b/a ICI Paints) at Strongsville Ohio 44136 and is referred to as the Master Palette® system. The Master Palette system describes some 6134 colors in its system plus a page of Brights and a page of Grays with an identifying number for each color. In essence numerical notations for the Master Palette color system stem from a dissection of the rainbow. Perceiving the standard color wheel known to those skilled in the art in the shape of a solid ball, the neutrals from black to white are on the vertical axis running through the center of the ball. This axis influences the light reflectance “value”, or how light or dark the color appears. The hues ranging from red, orange, yellow, green, blue to violet (roughly around 700 nanometer {“nm”} to around 380 nm in wavelength) for the visible spectrum form the ball. The distance from the axis determines the intensity of the colors, or chroma within the ball. The deeper or darker shades are closer to the center. These three values comprise the color notation. For example the notation “40YY/48/750” has the first (40YY) as the hue and color family. This color is 40 on a scale of 0-99 in the yellow/yellow family. The next two numbers (48) represent the light reflectance value on a scale of 0-99, where the higher the number, the lighter the color. The last three numbers (750) represent the chroma on a scale of 0-999: the higher the number, the more intense the color. Therefore for the original example notation, the color is a medium-deep intensity, medium-light yellow. Every hue or color family has its darker hues as mentioned above deeper or darker shades are closer to the center on the color ball. For instance for reds, blues, violets, browns, burgundies, greens, yellows such as gold with a color number greater than 50 and more suitably greater than 60 would be a darker hue for these particular colors. Also, blacks and dark shades of gray would be darker hues. Additionally, higher saturated colors can also be used. Another suitable color system available through ICI Paints can generally be described as the Ralph Lauren (RL) Lifestyle Colors (http://rlhome.polo.com/rlhome/products/paint/lifestyle.asp) which currently describes some 504 colors or more in its system.

The topcoat which is usually applied to the base coat any time after it is dried is a latex coating composition having at least one acrylic containing latex. Suitable acrylic or vinyl-acrylic resin, or binder as it is commonly referred to, for the latex provides a durable and flexible matrix within which the reflective particles are dispersed and suspended. The binder binds the reflective particles, glass beads, glass spheres or hollow glass spheres together and provides integrity and adhesion for the decorative surface coating. The binders for water-borne decorative surface coatings are typically produced by free radical initiated aqueous emulsion polymerization of a monomer mixture which contains alkyl acrylate (e.g., methyl acrylate, ethyl acrylate, butyl acrylate and/or 2-ethylhexylacrylate), alkyl methacrylate, vinyl alcohol/acetate, styrene, and, to a lesser extent, acrylonitrile and ethylene type monomers. The 100 percent acrylic resins typically exhibit a better performance, but are generally more expensive. The pure vinyl (e.g., polyvinyl alcohol/acetate) resins are considerably less expensive, but generally exhibit poor water resistance. Mixed vinyl-acrylic resins are commonly used in decorative surface coatings in both U.S. and Canada. The polymer is typically dispersed in water. Non-exclusive suitable resins/binders under this disclosure can include those available as Acrylic Latex Emulsions from Dow Chemical, and Rhoplex latexes available from Rohm and Haas Company such as, Rhoplex SG-30 or Rhoplex AC-2508, Vinyl Acetate latexes also available from Rohm and Hass Company, Polyvinyl Alcohol available from Celanese, Styrene Acrylics available from BASF, and Vinyl Acrylics from Dow Chemical, and poly(vinylalcohols) available from Air Products and Chemical such as Airvol 523 PVA. Generally, the binder accounts for about 10 percent to about 50 percent of the final formulation, although there may be situations where the binder content could be slightly higher than this amount.

In addition to the acrylic containing latex, the topcoat suitably has at least one defoamer, at least one rheology modifier, at least one coalescing agent, at least one dispersant, at least one surfactant and most suitably at least one biocide. Together, these additives generally account for between about 10 percent to about 25 percent of the final formulation.

Defoamers represent a specialized group of surfactants that are added to a water-borne decorative surface coating to decrease the foaminess of an agitated, or mixed, decorative surface coating when it is manufactured, shaken or stirred, or when it is mixed just prior to application. Suitable defoamers under this disclosure can include Drewplus T4507 (Drew Industries), Drewplus L475 (Drew Industries), Foamstar A-38 (Cognis), and Tego Foamex 810 (Degussa-Golschmidt Chemical Corporation). Generally, defoamers account for only about 3 percent by weight, or less of the final product formulation, and in many product formulations, more suitably, less than 1 percent by weight.

Rheology modifiers/thickeners can be added to the water-borne decorative surface coating to thicken the coating formulation, as well as to increase its yield stress of the water-resin system, thus allowing for a more stable suspension of the reflective particles in the resin matrix upon mixing. Rheology modifiers can also play an important role in optimization of the application properties for certain decorative surface coatings. Suitable rheology modifiers/thickeners under this disclosure can include Acrysol RM-825 (Rohm and Hass Corporation), Natrosol Plus 330 (Hercules, Inc.), and Cellosize QP-15000-H (Dow Chemical). Generally, rheology modifiers/thickeners account for only about 3 percent by weight, or less of the final product formulation, and in many product formulations, more suitably, less than 1 percent by weight. Also with or without rheology modifiers, one or more thickeners can be used in the water-borne decorative surface coating.

Coalescing Agents can be added to water-borne decorative surface coatings to aid in the formation of a film, to somewhat resist freezing, and/or to enhance certain application properties by increasing the open time which is demonstrated by the particular decorative surface coating. Open time can be characterized as the time during which a decorative surface coating remains workable subsequent to its application onto a substrate. Longer periods of open time allows for the re-brushing or melting in of the newly applied decorative surface coating while at the same time minimizing the occurrence of brush marks, loss of gloss, or lap lines in the dried application. Lap lines are lines which can be formed when one application of the decorative surface coating is applied onto a portion of the substrate which has previously been coated, but which has not yet dried thoroughly. Typically, the amount of coalescing agents in a typical decorative surface coating can be 10 to 20 percent of the total liquid content of the decorative surface coating. Coalescing agents can also be referred to as coalescing solvents and/or co-solvents. Suitable coalescing agents under this disclosure can include ethylene glycol (Dow Chemical), diethylene glycol (Dow Chemical), propylene glycol (Dow Chemical), Texanol (Eastman Chemical), and Dowanol (Dow Chemical). Generally, coalescing agents account for only about 15 percent by weight, or less of the final product formulation, and in some product formulations, more suitably, less than 5 percent by weight.

Dispersants can be added to the water-borne decorative surface coatings to create a stable dispersion of the pigments, or in this case the reflective particles. Dispersants function by interacting directly with the reflective particles, both mechanically and electrostatically. Suitable dispersants under this disclosure can include Tamol 731A (Rohm and Haas), Hydroplat 44 (Cogins), AMP-95 (Dow Chemical), and Tamol 165A (Rohm and Haas Company). Generally, dispersants account for only about 6 percent by weight, or less of the final product formulation.

Surfactants represent a group of additives that aid in the formulation process, as well as during the application and curing process. Certain types of surfactants can improve the leveling properties of water-borne decorative surface coatings by changing its surface tension properties and/or wetting properties. Better surface wetting allows for better adhesion of the wet coating, as well as the dried film. Suitable surfactants under this disclosure can include Igepal CTA-639-W (Rhodia, Inc.), Surfynol CT 131 (Air Products), Surfynol 104 PG-50 (Air Products), and Triton X-405 (Cognis). Generally, surfactants account for only about 3 percent by weight, or less of the final product formulation, and in many product formulations, more suitably, less than 1 percent by weight.

Biocides and/or mildewcides can be added to the formulation of a water-borne decorative surface coating t aid in the control of microbial growth in the formulation while it is in the packaging container, as well as in the dried paint film. Microbial growth in the paint formulation can contribute to bad odors, not to mention overall spoiling of the paint formulation. Some biocides may be added to the coatings formulation solely to control microbial growth while the coating remains inside of the packaging unit, commonly referred to as in-can preservatives. Other biocides may function to impart biostability to the dried/cured coating film. Suitable biocides under this disclosure can include Dowcil 75 (Dow Chemical), and Proxel GXL (Arch Chemicals, Inc.). Generally, biocides account for less than 1 percent by weight of the final product formulation.

Other additives such as film formers and suspension agents represent ingredients that can be added to a water-borne decorative surface coating in small amounts to provide specific properties to the paint formulation and/or the dried/cured coating film that might not otherwise be present such as suspension stability, anti-fading, heat stability, film hardening, etc. Suitable additives under this disclosure can include Texanol: UCAR (Dow Chemical), Tegmer 804 (C.P. Hall Company), Attagel 50 (Engelhard Corporation), ASP-602 (Engelhard Corporation), Archer RC (ADM Linseed Oil), Tegmer 804 (C.P. Hall Company), and Lattice NTC-80 (FMC Corporation). Generally, other additives account for only about 3 percent by weight or less of the final product formulation.

Reflective particles such as, for example, glass beads or hollow glass spheres are added to the water-borne decorative surface coating formulation in an amount of at least 15 percent to a maximum of 50 percent, by weight, to impart a reflective property in the final dry/cured film of the top coat. Depending upon the size and properties of the beads/spheres being utilized, the reflective properties can become more or less apparent. Suitable glass spheres have a refractive index greater than 1.88, and more suitable retroreflective glass beads have a higher refractive index between 1.90 and 2.30. In one particular embodiment of this disclosure, the glass spheres have pre-determined sizes and refractive indices so as to impart the desired reflective finish. This embodiment is based upon the addition of T-4 Sign Beads; Glass Oxide are high-density barium titanate glass beads manufactured by Flex-o-lite, Inc. and distributed by Potters Industries Inc. The T-4 Sign Beads are high-index retrorefractive glass spheres with a particle size of between 40-100 microns, and a refractive index of about 1.90 to 1.92.

The topcoat in one particular suitable embodiment is essentially free of intentionally added calcium carbonate as a type of filler opacifying agent. Most suitably the topcoat is substantially transparent so it is essentially free of intentionally added pigments which would otherwise serve to make the topcoat opaque. With such a formulation on the at least one base coat the attainment of the “sparkling” property has been achieved without the intentional addition of any opacifying agents like calcium carbonate.

The ingredients for a water-borne decorative surface coating are dissolved, suspended and/or dispersed in a carrier such as tap water, deionized tap water, or deionized water from any source. Water is the principal carrier of importance when discussing water-borne decorative surface coatings. Water typically accounts for about 50 percent, by weight, of many of the water-borne decorative surface coatings, although there are formulations that have more or less than this amount.

Water-borne decorative coatings cure when the evaporation of water and other volatile ingredients, such as the coalescing agents/solvents, occurs. As a result of this evaporation process the resin/binder and the reflective particles begin to coalesce into a continuous phase or film. The curing process is complete once substantially all of the water and other volatile ingredients that were contained within the original formulation have evolved.

Preferably, the water-borne decorative surface coatings of the present disclosure have a viscosity that allows for ease of application. The viscosity can be measured using a Brookfield RVT viscometer using a 5, 6 or 7 spindle at greater than 10 rpm. Preferably, the viscosity is less than about 100,000 centipoise, more preferably less than about 80,000 centipoise, even more preferably less than about 65,000 centipoise, and most preferably less than about 50,000 centipoise.

The top coat water-borne decorative coatings can be prepared with the components as mentioned above such as with the component materials shown for illustrative purposes in the Examples below. The method of making the top coat with such components can utilize normal blending techniques that are familiar to someone experienced in the art of manufacturing and/or blending paint products (e.g., dispersing, mixing, blending, thinning, adjusting, and the like). For example, the compositions of the examples listed below can be prepared on a small scale where component 1 along with portions of components 2 and 18 are added to a thin-down tank with a turbine blade. Also, component 5 is added along with portions of components 4 and 20 into a separate dispersion vessel fitted with a cowls-type blade. The initial dispersion is dispersed for a minimum of 5 minutes, after which time another portion of components 2 and component 18 are added to the disperser. Components 6, 8, 9, 10 and 12 are also added to the disperser and the combination is mixed at high speed for a minimum of 10 minutes. Once the mixing is completed, components 11, 13, 14, and another portion of component 18 are added to the disperser. The components are allowed to mix at high speed for an additional 30 minutes, but the temperature of the paste should not be allowed to exceed 120 degrees Fahrenheit. The resultant paste is added to the initial mixture contained in the thin down tank by rinsing the paste from the disperser using another portion of component 18. While this mixture (initial thin down plus the paste) is being mixed, additional portions of components 4 and 18 are pre-mixed in a separate mixing vessel fitted with a cowls-type agitator, and added to the batch by rinsing the mixing vessel with a another portion of component 18. Once the pre-mix is added to the batch the consolidated batch is allowed to mix at high speed for at least 30 minutes. Once the mixing is complete the remaining portions of components 2 and 18 are added along with components 7a, 16 and 3 to the thin down tank. The consolidated batch is then allowed to mix at high speed for a minimum of 5 minutes. Afterwards component 16 is added to the batch, and allowed to mix for an additional 30 minutes. Once this is complete component 17 is added to the batch, and allowed to mix for an additional 45 minutes under agitation.

The coatings formulations contained within this disclosure are useful as interior decorative surface coatings that can be used on a variety of substrates such as, for example, drywall, paper, wood, plastic, concrete, metal, glass, plaster, plasterboard, previously primed or coated surfaces, and the like. Preferred substrates are architectural substrates such as walls, trim, clapboard, siding, window frames, ceilings, gypsum board, and the like. Application of the water-borne decorative surface coatings described within this disclosure can be achieved in a number of manners such as, for example, brush, rollers, mops, air-assisted or airless spray, and electrostatic spray. In order to achieve the best results, application should be with the use of a textured roller such as, for example, a regent metallic™ roller which is available at a variety of home remodeling stores, building material retailers, as well as ICI Paints Stores.

Both the at least one base coat and the top coat can be applied to the surface of a substrate with a brush, sponge, rag, roller, and/or spraying device. A suitable application device for both the base coat and the top coat is a roller. Conventionally, rollers are used mounted on a central axle attached to a handle so that in use, the roller has a proximal end attached to the handle and a distal end remote from the handle. Any known applicators for paint can be used and rollers are conventionally used with a pan of paint and the roller is rolled or dipped into the paint and rolled onto the surface to be painted. More suitably for the topcoat, a roller is used and the roller can have a cover over the frame or support that is textured. Virtually any material can be used in forming applicator cover or outer sleeve. Such materials include, inter alia, synthetic and natural fibers, including, for example, open and closed foams, mohair, wool, rubber, rags, fleece, plastics, wood, and the like. Depending upon the material used and other factors, the roller can be manufactured in its disclosed structure. This texture can be provided by outwardly extending fibers or strands or a sponge-type roller having depressions or crevices in a pattern across the surface of the cover to provide the textured surface. A suitable useful roller can have an outer sleeve or cover provided with fibers extending outwardly from the sleeve wherein the fibers have a length of around 1 mm and more suitably from 5 to 25 mm.

When transferring the topcoat to the wall, the rolled areas or strips of coating should not overlap each adjacent rolled area at the risk of destroying part of the pattern already laid down. To avoid leaving a “track” or ridge of topcoat that must be smoothed over with each adjacent area being painted, then the rollers have their edges beveled. Such edge beveling permits the rolled area to place each adjacent pattern directly in abutting juxtaposition with each adjacent pattern without overlapping the prior pattern. A suitable bevel angle for each edge of the roller can be between 5 and 60 degrees, of course those skilled in the art can recognize that the bevel angle can be varied to accommodate the surrounding areas of applied coating while eliminating or reducing the need for masking. In one more suitable embodiment, the beveled surface is oriented at a bevel angle of about 25 to 45 degrees with respect to the planar painting surface.

In one particular embodiment of the present disclosure a suitable application technique that can be used for the reflective topcoat can be described as a modified random rolling technique. For such a technique the substantially transparent coating composition can be applied by beginning in the top corner of the work area (e.g., a wall or potion of a room that is being decorated or redecorated, etc.) with a trim roller (e.g., nominally a 4-inch, 4.5-inch or 5-inch paint roller) to cut in an area approximately 9-inches wide and the full height of the work area, including along the top, bottom and vertical edge. Then, use a standard-sized paint roller (typically a 9-inch to 10-inch paint roller) to apply the reflective topcoat composition from top to bottom over this segmented portion of the work area (two adjacent columns). Repeat this same procedure in a second segmented work area of approximately the same width to the area which has just now been painted, again cutting in the work area with a trim roller at the top and bottom of the column. The two columns can then be blended together by vertically rolling over the seam without reloading the paint roller with any additional coating materials. Once this has been accomplished, gently roll a series of X's (e.g., crisscross pattern) across the two 9 or 10-inch columns from top to bottom of the adjacent columns, also without reloading the paint roller with any additional coating materials. Repeat this same sequence of procedures until the entire work area has been coated. A more detailed description of this recommended procedure, including diagrams, can be found at RLHome.Polo.com (http://rlhome.polo.com/rlhome/prod_pdf/candlelight_howto.pdf), which is incorporated herein.

The following examples are provided to further illustrate aspects of the invention. These examples are non-limiting and should not be construed as limiting any aspect of the invention.

### EXAMPLES

| | | Example 1 | Example 2 | Example 3 | Example 4 | Example 5 |
|---|---|---|---|---|---|---|
| | | wt % | wt % | wt % | wt % | wt % |
| 1) | Acrylic/Vinyl-Acrylic | 37.3 | 39.2 | 40.4 | 42.7 | 42.7 |
| | Resin | | | | | |
| 2) | Defoamer 1 | 0.786 | 0.783 | 0.798 | 0.759 | 0.759 |
| 3) | Defoamer 2 | 0.098 | 0.098 | 0.133 | 0.133 | 0.133 |
| 4) | Cellulosic Thickener 1 | 0.639 | 0.637 | 0.569 | 0.531 | 0.531 |
| 5) | Cellulosic Thickener 2 | 0.117 | 0.117 | 0.114 | 0.114 | 0.114 |
| 6) | Ethylene Glycol | 2.260 | 1.958 | 0 | 2.182 | 10.436 |
| 7a) | Diethylene Glycol | 6.880 | 2.936 | 0 | 8.254 | 0 |
| 7b) | Propylene Glycol | 0 | 0 | 10.449 | 0 | 0 |
| 8) | Anionic Dispersant 1 | 0.491 | 0.489 | 0.522 | 0.522 | 0.522 |
| 9) | Anionic Dispersant 2 | 0.098 | 0.098 | 0.09 | 0.09 | 0.09 |
| 10) | AMP-95 Dispersant | 0.138 | 0.147 | 0.171 | 0.171 | 0.171 |
| 11) | Polymeric Dispersant | 3.44 | 3.426 | 3.515 | 3.51 | 3.51 |
| 12) | Nonionic Surfactant | 0.245 | 0.245 | 0.266 | 0.266 | 0.266 |
| 13) | Colloidal Silicate | 0.294 | 0.294 | 0.285 | 0.285 | 0.285 |
| | Thickener | | | | | |
| 14) | Aluminum Silicate | 0.294 | 0.294 | 0.285 | 0.285 | 0.285 |
| | Thickener | | | | | |
| 15) | Texanol; UCAR | 1.671 | 1.664 | 1.615 | 1.613 | 1.613 |
| | Filmer | | | | | |
| 16) | Proxel GXL | 0.117 | 0.117 | 0.114 | 0.114 | 0.114 |
| | Mildewcide | | | | | |
| 17) | T-4 Sign Beads | 18.7 | 19.575 | 21.848 | 21.821 | 21.821 |
| 18) | Tap Water | 26.432 | 27.922 | 18.826 | 16.65 | 16.65 |

As an example of the multi-layer water-borne decorative surface coating system, an interior wall was first coated with a Ralph Lauren (“RL”) Lifestyles color of Light Sky (color code IB81), and allowed to air dry. This coating layer was top coated with the RL Candlelight® finish, and then observed. The Sky Blue selection represented a deeper hue or color base coat, and the observations made subsequent to the application of the RL Candlelight® top coat showed no apparent signs of cloudiness which was visible to the naked eye. The resultant finish was visually observed as sparkling, as opposed to the initial finish that was demonstrated by application of the basecoat alone.

What is claimed is:

1) A multi-layer water-borne decorative surface coating system comprising:
at least one opaque base decorative surface coating layer; and
a substantially transparent top decorative surface coating layer containing reflective particles, the top decorative surface coating layer having an upper and lower surface, the lower surface being in contact with the opaque base decorative surface coating layer, and the reflective particles protruding from the upper surface of the top decorative surface coating layer, and
wherein the reflective particles comprise greater than 15 percent, but less than 50 percent, by weight of the top decorative surface coating layer, and
wherein the reflective particles exhibit a refractive index of greater than 1.88, and
wherein the substantially transparent top decorative coating layer is essentially free of intentionally added calcium carbonate.

2) The multi-layer water-borne decorative surface coating system in claim 1, wherein the opaque base decorative surface coating layer is other than a flat finish having a gloss greater than 5 gloss units at 85 degrees using a commercially-available gloss meter such as a Byk Gardner.

3) The multi-layer water-borne decorative surface coating system in claim 1, wherein the thickness of the substantially transparent top decorative surface coating layer is less than 500 um.

4) The multi-layer water-borne decorative surface coating system in claim 1, wherein greater than 10% by weight of the reflective particles protrude from the upper surface of the substantially transparent top decorative surface coating layer.

5) The multi-layer water-borne decorative surface coating system in claim 1, wherein the reflective particles are solid reflective spheres.

6) The multi-layer water-borne decorative surface coating system in claim 5, wherein the reflective particles exhibit an index of refraction between 1.90 and 2.30.

7) The multi-layer water-borne decorative surface coating system in claim 1, wherein the substantially transparent top decorative surface coating layer comprises an acrylic or vinyl acrylic base resin.

8) The multi-layer water-borne decorative surface coating system in claim 1, wherein the substantially transparent top decorative surface coating layer is essentially free of intentionally added opacifying agents selected from the group consisting of calcium carbonate, titanium dioxide.

9) The multi-layer water-borne decorative coating system in claim 8, wherein the coating system is also essentially free of opacifying agents other than calcium carbonate and titanium dioxide.

10) The multi-layer water-borne decorative surface coating system in claim 1, wherein the at least one opaque base decorative base coating layer is of a darker color hue of black, blue, green, brown, yellow, red, or some combination thereof.

11) A substantially transparent decorative surface coating comprising:
from about 65 to about 85% by weight of a clear polymer base resin having a viscosity from about 70 to about 120 Krebs units; and
reflective particles comprising greater than 15 percent, but less than 35 percent, by weight of the substantially transparent decorative surface coating, and
wherein the reflective particles exhibit a refractive index greater than 1.88, and
wherein the substantially transparent decorative surface coating is free of intentionally added opacifying agents.

12) The substantially transparent decorative surface coating in claim 10, wherein about 95 to 100% by weight of the reflective particles have a refractive index greater than 1.88, and an average diameter from about 40 to about 100 um.

13) The substantially transparent decorative surface coating in claim 10, wherein the reflective particles are solid reflective spheres.

14) The substantially transparent decorative surface coating in claim 10, wherein the clear polymer base resin is an acrylic or vinyl acrylic resin.

15) The substantially transparent decorative surface coating in claim 12, wherein about 95 to 100% by weight of the solid reflective spheres have a refractive index greater than 1.88, and an average diameter from about 40 to about 100 um.

16) The substantially transparent decorative surface coating in claim 10, wherein the substantially transparent top decorative surface coating is essentially free of calcium carbonate.

17) The substantially transparent decorative surface coating in claim 10, wherein the substantially transparent top decorative surface coating is essentially free of calcium carbonate and titanium dioxide.

18) A two-layer water-borne decorative surface coating system comprising:
an opaque base decorative surface coating layer; and
a substantially transparent top decorative surface coating layer containing reflective particles, the top decorative surface coating layer having an upper and lower surface, the lower surface being in contact with the opaque base decorative surface coating layer, and the reflective particles protruding from the upper surface of the top decorative surface coating layer.
wherein the reflective particles are solid reflective spheres.
wherein the solid reflective spheres comprise between about 18 to about 24 percent by weight of the top decorative surface coating layer.
wherein the opaque base decorative surface coating layer is a semi-gloss finish exhibiting greater than 5 gloss units at 85 degrees using a commercially-available gloss meter such as Byk Gardner.
wherein the thickness of the substantially transparent top coating layer is less than about 450 um.
wherein greater than 10% by weight of the solid reflective spheres protrude from the upper surface of the substantially transparent top decorative surface coating layer.
wherein the solid reflective spheres have an index of refraction of from about 1.90 to about 1.93.
wherein the substantially transparent top coating layer comprises an acrylic or vinyl acrylic base resin.
wherein the substantially transparent top decorative surface coating layer is essentially free of intentionally added calcium carbonate, titanium dioxide, and other like ingredients.

19) A method of applying at least a substantially transparent topcoat water borne coating composition for a reflective appearance in visible light, comprising:
a) applying to at least one opaque base decorative surface coating layer a substantially transparent top coat decorative surface coating layer comprising reflective particles in an amount greater than 15 percent, but less than 50 percent, by weight of the top decorative surface coating layer wherein the reflective particles exhibit a refractive index of greater than 1.88, and wherein the substantially transparent top decorative coating layer is essentially free of intentionally added calcium carbonate and titanium dioxide opacifying agents by:
i. applying the top coat composition in the top corner of a first column of the work area with a trim roller to cut in an area of at least 9-inches wide and the full height of the work area, including along the top, bottom and vertical edge.
ii. Applying with a standard-sized paint roller (typically a 9-inch to 10-inch paint roller) the reflective topcoat composition from top to bottom forming the first column of the work area;
iii. applying with a standard-sized paint roller the reflective topcoat composition to an already cut in top and bottom to form an adjacent column of the work area
iv. blend the applied coating composition together in the two columns by vertically rolling over the seam without reloading the paint roller with any additional coating materials;
v. gently roll a series of crisscross patterns across the two adjacent columns from top to bottom of the adjacent columns, also without reloading the paint roller with any additional coating materials to coat this segmented portion of the work area;
vi. repeat, steps i) through and including v) in the same sequence of until the entire work area has been coated.

20). In the method of claim 19, wherein the application of the topcoat composition is made with a trim roller to cut in a plurality of columns or segmented portions of the work area.
